(19) United States
(12) Patent Application Publication
(10) Pub. No.: US 2025/0077552 A1
(43) Pub. Date: Mar. 6, 2025

(54) DATA CLASSIFICATION METHOD FOR FILTERING OUTLIER TEXT DATA

(71) Applicant: HTC Corporation, Taoyuan City (TW)

(72) Inventors: Chen-Han TSAI, Taoyuan City (TW); Yu-Shao PENG, Taoyuan City (TW)

(21) Appl. No.: 18/818,623

(22) Filed: Aug. 29, 2024

Related U.S. Application Data
(60) Provisional application No. 63/579,514, filed on Aug. 30, 2023.

(51) Int. Cl. G06F 16/332; G06F 16/35

(52) U.S. Cl. CPC G06F 16/3329; G06F 16/353

(57) ABSTRACT

A data classification method includes following steps. Text samples are obtained from a dataset. The text samples are converted into text embeddings in a semantic space. An outlier-inlier ranking of the text samples is generated based on an outlier detection algorithm according to distances between the text embeddings in the semantic space. Partial samples are selected from the text samples according to the outlier-inlier ranking. A manual input command is received to assign manual-input labels on the partial samples. A prompt message is generated according to the partial samples with the manual-input labels and unlabeled samples of the text samples. The prompt message is provided to a generative pre-trained transformer model for generating inlier-outlier prediction labels about the unlabeled samples.

### RELATED APPLICATIONS

This application claims the priority benefit of U.S. Provisional Application Ser. No. 63/579,514, filed Aug. 30, 2023, which is herein incorporated by reference.

### BACKGROUND

### Field of Invention

The disclosure relates to a classification method. More particularly, the disclosure relates to a classification method for identifying inlier or outlier among unlabeled data.

### Description of Related Art

Outlier detection in machine learning technology is the process of identifying data instances that deviate significantly from the normal distribution within a dataset. Detecting outliers is crucial in various applications, including medical prediction, fraud detection, network security, quality control, and anomaly detection in healthcare or industrial processes.

### SUMMARY

An embodiment of the disclosure provides a data classification method, which includes following steps. Text samples are obtained from a dataset. The text samples are converted into text embeddings in a semantic space. An outlier-inlier ranking of the text samples is generated based on an outlier detection algorithm according to distances between the text embeddings in the semantic space. Partial samples are selected from the text samples according to the outlier-inlier ranking. A manual input command is received to assign manual-input labels on the partial samples. A prompt message is generated according to the partial samples with the manual-input labels and unlabeled samples of the text samples. The prompt message includes a task instruction, unlabeled data and anchor data generated based on the partial samples with the manual-input labels. The prompt message is provided to a generative pre-trained transformer model for generating inlier-outlier prediction labels about the unlabeled samples.

Another embodiment of the disclosure provides a data classification method, which includes following steps. Text samples are obtained from a dataset. The text samples are converted into text embeddings in a semantic space. An outlier-inlier ranking of the text samples is generated based on an outlier detection algorithm according to distances between the text embeddings in the semantic space. Partial samples are selected from the text samples according to the outlier-inlier ranking. A manual input command is received to assign manual-input labels on the partial samples. A first prompt message is generated to include the partial samples with the manual-input labels and a feature engineering task instruction. The first prompt message is provided to a generative pre-trained transformer model for generating distinguishable features. A second prompt message is generated to include the distinguishable features, the text samples and a feature scoring task instruction. The second prompt message is provided to the generative pre-trained transformer model for generating feature predictions of the text samples relative to the distinguishable features. The text samples include the partial samples and unlabeled samples. A classification algorithm is performed based on the feature predictions of the text samples, so as to generate inlier-outlier prediction labels about the unlabeled samples.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram illustrating an electronic device according to some embodiments of the disclosure.

FIG. 2 is a flowchart illustrating a data classification method according to some embodiments of the disclosure.

FIG. 3A is a schematic diagram illustrating text samples obtained from the dataset.

FIG. 3B is a schematic diagram illustrating text embeddings in the semantic space corresponding to the text samples obtained from the dataset.

FIG. 3C is a schematic diagram illustrating the outlier-inlier ranking of the text samples in some embodiments.

FIG. 3D is a schematic diagram illustrating the partial samples and the manual-input labels about the partial samples in some embodiments.

FIG. 3E is a schematic diagram illustrating how to generate the prompt message according to the partial samples with the manual-input labels and unlabeled samples of the text samples in some embodiments.

FIG. 4 is a schematic diagram illustrating the prompt message in some embodiments.

FIG. 5 is a flowchart illustrating a data classification method according to other embodiments of the disclosure.

FIG. 6 is a schematic diagram illustrating the first prompt message in some embodiments.

FIG. 7 is a schematic diagram illustrating the second prompt message in some embodiments.

FIG. 8 is a schematic diagram illustrating how to generate inlier-outlier prediction labels by the classification algorithm in some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

While developing a chatbot or a large language models (LLM), it is important to collect training datasets containing input texts and the corresponding output texts. For example, while developing the chatbot, the input text could be sample questions from potential users, and the output text would be the answers that the chatbots should provide. These training datasets are used both for model development (e.g., building the chatbot) and model evaluation (e.g., evaluating preciseness or performance of the chatbot). Traditionally, the training datasets are created by a group of human annotators, but employing such a team is very expensive. Some automatic generators are utilized to replace human annotators for providing generated texts in the training dataset, so as to reduce the cost and time required to build the training datasets. Because the quality of generated texts produced by the automatic generators is unstable, it is needed to perform verification on the generated texts.

The verification is utilized to remove low-quality samples (i.e., improper generated texts) from the training datasets. Remaining generated texts in the training dataset are then used during model development and also during model evaluation. Low-quality samples severely impact model performance. Thus, removing low-quality samples during the verification is helpful in developing quality models.

In some cases, the generated datasets contain more than 100,000 sample texts that require verification. One solution would be to employ human annotators to manually check the quality of every sample text. However, the cost of manual checking is exceedingly high, and this manual checking process is painfully slow as well.

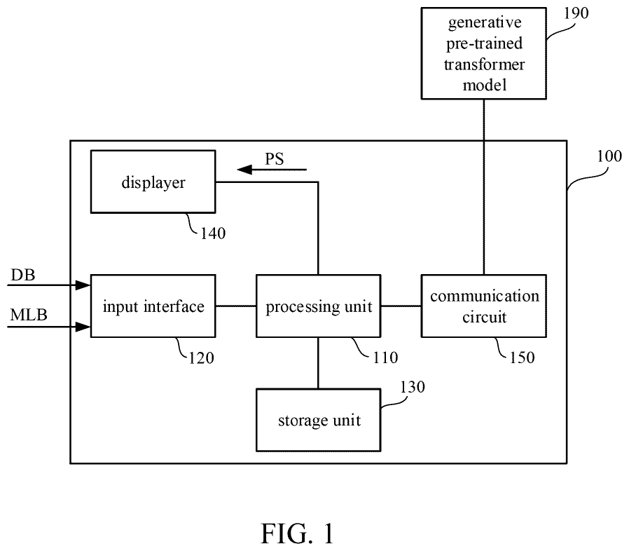

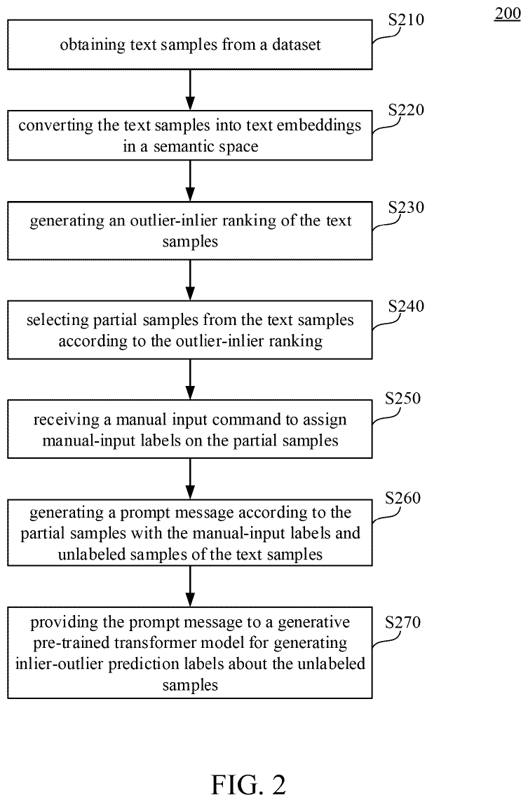

Reference is further made to FIG. 1 and FIG. 2. FIG. 1 is a block diagram illustrating an electronic device 100 according to some embodiments of the disclosure. FIG. 2 is a flowchart illustrating a data classification method 200 according to some embodiments of the disclosure. The data classification method 200 is configured to generate inlier-outlier predictions about text samples in a dataset DB. The dataset DB can be obtained from a text-content server. For example, the dataset DB can be collected from an encyclopedia website, a news website, a Q&A database, a discussion forum, a novel storage server, a journal database or any similar storage center of text contents.

As shown in FIG. 1, the electronic device 100 includes a processing unit 110, an input interface 120, a storage unit 130, a displayer 140 and a communication circuit 150. In some embodiments, the electronic device 100 can be a computer, a smartphone, a tablet, an image processing server, a data server or any equivalent image processing device. The input interface 120 is configured to receive the dataset DB and manually input instructions. In some embodiments, the electronic device 100 is configured to classify the text samples in the dataset DB, generate inlier-outlier predictions of the text samples, remove outlier samples and keep inlier samples according to the inlier-outlier predictions.

The input interface 120 can include a data transmission interface, a wireless communication circuit, a keyboard, a mouse, a microphone or any equivalent input device. The processing unit 110 is coupled with the input interface 120, the storage unit 130, the displayer 140 and the communication circuit 150. The storage unit 130 is configured to store a program code. The program code stored in the storage unit 130 is configured for instructing the processing unit 110 to execute the data classification method 200 shown in FIG. 2. In some embodiments, the processing unit 110 can be a processor, a graphic processor, an application specific integrated circuit (ASIC) or any equivalent processing circuit. The communication circuit 150 can be a network transceiver (e.g., a WiFi transceiver, a telecommunication transceiver or an Ethernet transceiver). The communication circuit 150 is configured to communicate with a generative pre-trained transformer (GPT) model 190. In some embodiments, the generative pre-trained transformer model 190 can be a separated model running on an external server outside the electronic device 100.

It is desirable to train a machine learning model according to a training dataset without the outliers. If the training dataset includes outliers, it can have several effects on the performance and behavior of machine learning models. For example, the outliers in the training dataset may cause issues like model bias, increased model complexity, overfitting, reduced robustness, and difficulty in anomaly detection.

In a large language model (LLM) application, unlabeled text passages in the training dataset DB can include different kinds of text contents, such as News reports, fictions, novels, banking statements, chatting records, questions-and-answers, research papers or programming codes. These different text contents have different usages in different fields. These text contents must be filtered to get rids of noisy data and extract clean data (e.g., valid text samples) for training a machine learning model for a specific purpose.

If our goal is training a machine learning model to answer a medical question, text contents about medical records, health discussions, diagnosis, symptoms and/or medicine histories should be regarded as inlier text samples; and other text contents about global warming, finical crisis and/or baseball games should be regarded as outlier text samples.

Manually labeling inliers and outliers within the dataset DB can be a time-consuming and costly process, especially when dealing with large datasets. It requires human experts to review and identify inliers and outliers, which can be impractical for big datasets with a lot of text samples.

In some embodiments, the electronic device 100 and the data classification method 200 provides a time-efficient and cost-efficient way to generate inlier-outlier predictions of the text samples in the dataset DB.

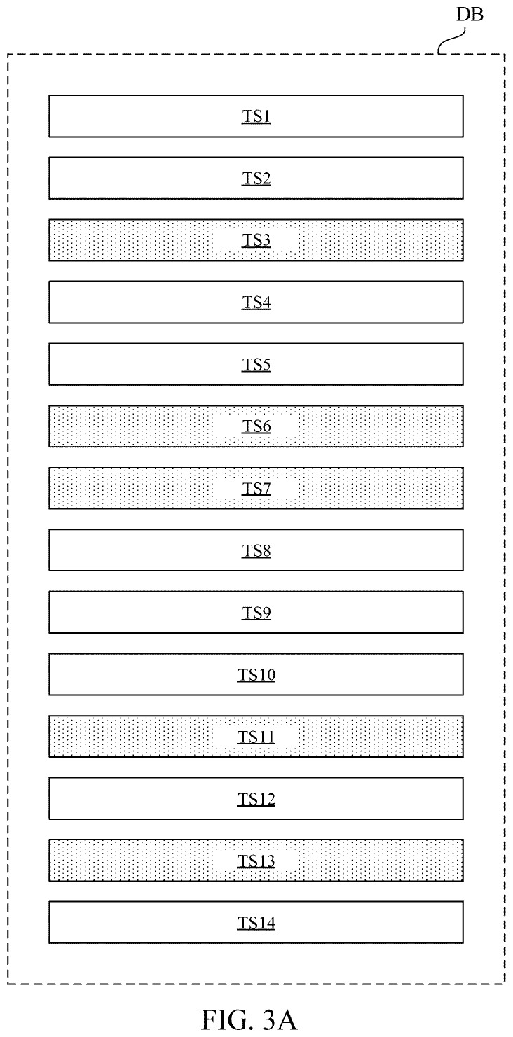

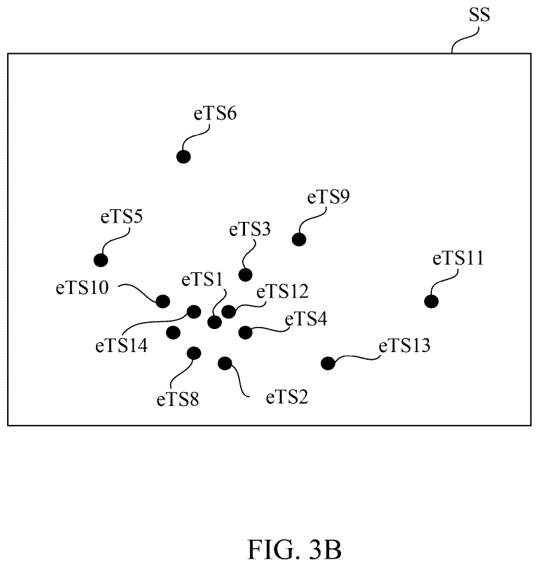

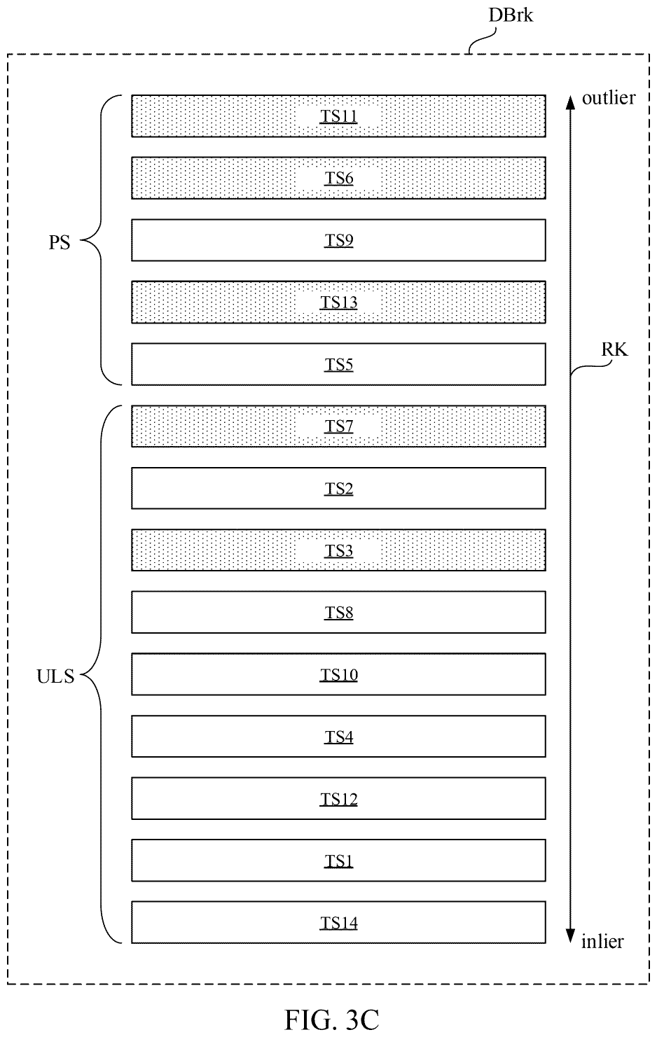

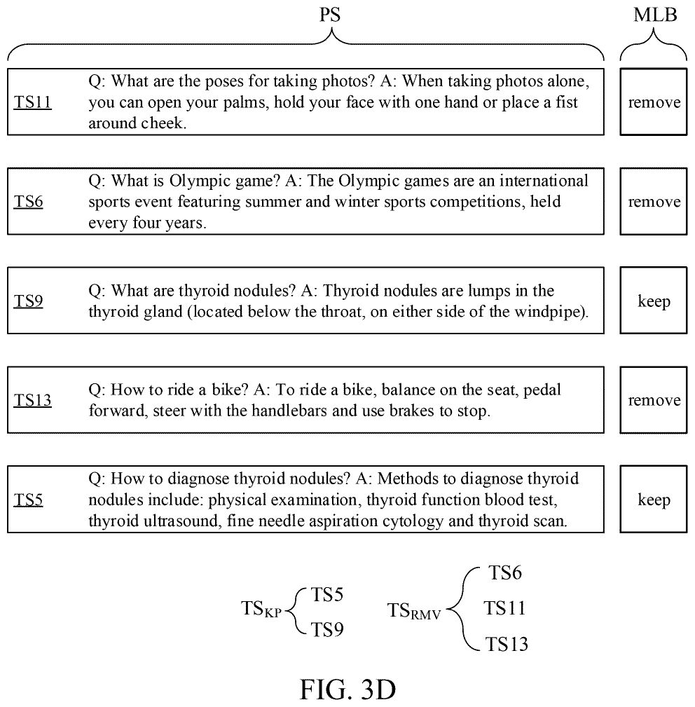

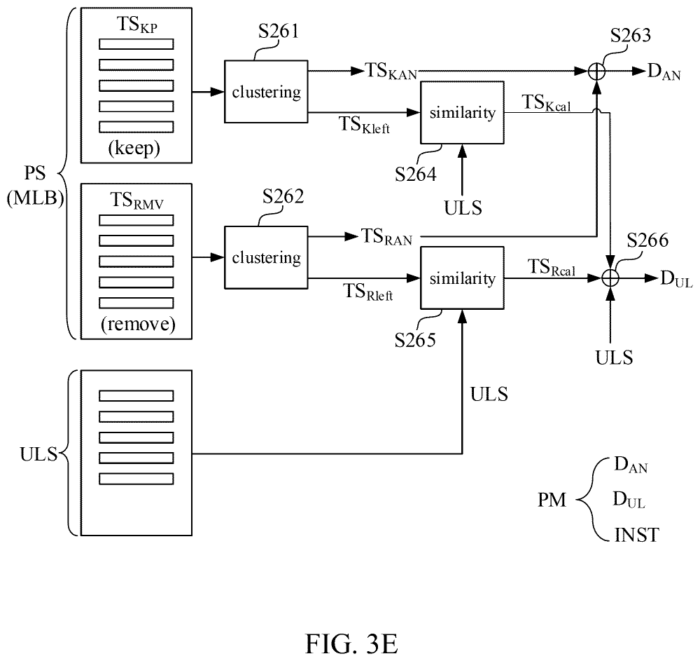

As shown in FIG. 1 and FIG. 2, step S210 is executed, by the processing unit 110, to obtain text samples from the dataset DB. Reference is further made to FIG. 3A, which is a schematic diagram illustrating text samples TS1, TS2, TS3 . . . . TS14 obtained from the dataset DB. Each of the text samples TS1-TS14 can be a text passage (e.g., sentences, a paragraph or an essay) or a combination of a question and a response relative to the question. An amount of the text samples TS1-TS14 illustrated in FIG. 3A is an example for brevity of demonstration. This disclosure is not limited thereto. In practices, the dataset DB may include hundreds, thousands or more of the text samples. In some embodiments, the text samples TS1-TS14 can be obtained from the dataset DB by a text fragmenting algorithm executed by the processing unit 110.

For example, the text samples TS1 can be “Q: How to get rid of a headache? A: Try to place a heating pad on your neck”; the text samples TS2 can be “Q: How to reduce belly fat? A: Moderate exercises and a diet plan may help”; the text samples TS3 can be “Q: How is the weather today? A: It is sunny outside.” These text samples TS1-TS14 may include inliers about a medical topic (e.g., the text samples TS1 and TS2) and outliers not involving the medical topic (e.g., the text sample TS3). As shown in FIG. 3A, it is assumed that the text samples TS3, TS6, TS7, TS11 and TS13 are noisy data (i.e., the outlier samples not involving the medical topic), and the text samples TS1, TS2, TS4, TS5, TS8, TS9, TS10, TS12 and TS14 are clean data (i.e., the inlier sample about the medical topic). In this case, these text samples TS1-TS14 are originally unlabeled. The electronic device 100 and the data classification method 200 are configured to label these text samples TS1-TS14, so as to separate the noisy data from the clean data.

As shown in FIG. 1 and FIG. 2, step S220 is executed, by the processing unit 110, to converting the text samples TS1-TS14 into text embeddings in a semantic space. Reference is further made to FIG. 3B, which is a schematic diagram illustrating text embeddings eTS1-eTS14 in the semantic space SS corresponding to the text samples TS1-TS14 obtained from the dataset DB.

A text embedding eTS1 is a projection of the text sample TS1 into a high-dimensional latent space. The text embedding eTS1 in the semantic space SS is a vector, or a long sequence of numbers. For brevity, the semantic space SS illustrated in FIG. 3B is a two-dimensional distribution. In practices, the semantic space SS may have more dimensions, such as 768 dimensions or 1536 dimensions. If two of the text samples TS1-TS14 have a similar semantic meaning, corresponding two of the text embeddings eTS1-eTS14 will be adjacent to each other in the semantic space SS. If two of the text samples TS1-TS14 have a different semantic meaning, corresponding two of the text embeddings eTS1-eTS14 will be far from to each other in the semantic space SS.

As shown in FIG. 1 and FIG. 2, step S230 is executed, by the processing unit 110, to generate an outlier-inlier ranking of the text samples TS1-TS14 based on an outlier detection algorithm according to distances between the text embeddings eTS1-eTS14 in the semantic space SS. Reference is further made to FIG. 3C, which is a schematic diagram illustrating the outlier-inlier ranking RK of the text samples TS1-TS14 in some embodiments.

In some embodiments, the outlier detection algorithm can be implemented by a RANSAC-NN algorithm. In some other embodiments, the outlier detection algorithm can be an Isolation Forest algorithm or a Local Outlier Factor algorithm.

The processing unit 110 is configured to run the outlier detection algorithm (e.g., RANSAC-NN) on the text samples TS1-TS14 according to distances between the text embeddings eTS1-eTS14 in the semantic space SS, the processing unit 110 will obtain the ‘inlier score’ for each sample. The text embeddings eTS1-eTS14 adjacent to others (with shorter distances to others) will have a higher ‘inlier score’, and the embeddings eTS1-eTS14 far from others (with longer distances to others) will have a low ‘inlier score’. A text sample with an ‘inlier score’ approaching 1 indicates that this sample is usually of higher quality. A text sample with low ‘inlier score’ are often associated with lower quality. Since each ‘inlier score’ is associated with each one of the text samples TS1-TS14, the outlier-inlier ranking RK of the text samples TS1-TS14 can be generated.

According to the outlier-inlier ranking RK shown in FIG. 3C, the text samples TS11, TS6, TS9, TS13 and TS5 (with relatively lower inlier scores) are prone to be outlier, and the text samples TS11, TS6, TS9, TS13 and TS5 placed together on a top end of the outlier-inlier ranking RK as shown in FIG. 3C.

According to the outlier-inlier ranking RK shown in FIG. 3C, the text samples TS14, TS1, TS12, TS4, TS10, TS8, TS3, TS2 and TS7 (with relatively higher inlier scores) are prone to be inlier, and the text samples TS14, TS1, TS12, TS4, TS10, TS8, TS3, TS2 and TS7 placed together on a bottom end of the outlier-inlier ranking RK as shown in FIG. 3C.

As shown in FIG. 1, FIG. 2 and FIG. 3C, step S240 is executed, by the processing unit 110, to select partial samples PS from the text samples TS1-TS14 according to the outlier-inlier ranking RK. As shown in FIG. 3C, the text samples TS11, TS6, TS9, TS13 and TS5, prone to be outlier according to the outlier-inlier ranking RK, are selected as the partial samples PS. The partial samples PS are transmitted from the processing unit 110 to the displayer 140.

In some embodiments, a human annotator can review/verify the partial samples PS on the displayer 140, and then the human annotator can enter manual-input labels MLB about the partial samples PS through the input interface 120. Reference is further made to FIG. 3D, which is a schematic diagram illustrating the partial samples PS and the manual-input labels MLB about the partial samples PS in some embodiments.

As shown in FIG. 3D, the text contents of the partial samples PS include the text contents of the text samples TS11, TS6, TS9, TS13 and TS5 can be displayed on the displayer 140 as shown in FIG. 1. The human annotator can read the text contents about the text samples TS11, TS6, TS9, TS13 and TS5, and then enters manual-input labels MLB about the partial samples PS through the input interface 120. In some embodiments, the human annotator may choose to remove the text samples TS11, TS6 and TS13 (not related to the medical topic), and keep the text sample TS9 and TS5 (related to the medical topic).

As shown in FIG. 1, FIG. 2 and FIG. 3D, step S250 is executed to receive a manual input command (about the manual-input labels MLB) by the input interface 120, and to assign the manual-input labels MLB on the partial samples by the processing unit 110. As shown in FIG. 3D, the manual-input labels MLB include keep labels on the text samples TS5 and TS9, such that the text samples TS5 and TS9 are regarded as keep samples TS_{KP} among the partial samples PS. On the other hand, as shown in FIG. 3D, the manual-input labels MLB include remove labels on the text samples TS6, TS11 and TS13, such that the text samples TS6, TS11 and TS13 are regarded as remove samples TS_{RMV} among the partial samples PS.

As shown in FIG. 3C and FIG. 3D, the partial samples PS prone to be outlier (evaluated by the outlier detection algorithm based on the outlier-inlier ranking RK) are selected from the whole text samples TS1-TS14. In this case, the human annotator is not required to manually label each of the text samples TS1-TS14. The partial samples PS prone to be outlier will be presented to the human annotator. Other text samples (e.g., the text samples TS14, TS1, TS12, TS4, TS10, TS8, TS3, TS2 and TS7 in embodiments shown in FIG. 3C) not included in the partial samples PS will be regarded as unlabeled samples ULS. The partial samples PS are fewer than the unlabeled samples ULS. In practices, the dataset DB may include 10000 text samples, such that the partial samples PS will be a small portion compared to the unlabeled samples ULS, and also a small portion compared to the whole text samples in the dataset DB.

In aforesaid embodiments, there is one round of collecting annotation. In some other embodiments, the unlabeled samples ULS (e.g., the text samples TS14, TS1, TS12, TS4, TS10, TS8, TS3, TS2 and TS7 in embodiments shown in FIG. 3C) can go through another round of step S230 (generating another outlier-inlier ranking of the unlabeled samples ULS), S240 (selecting another group of partial sample) and S250 (receiving another set of manual-input labels MLB). In some embodiments, steps S230, S240 and S250 can be repeated for a certain number of iterations.

As shown in FIG. 1 and FIG. 2, step S260 is executed, by the processing unit 110, to generate a prompt message according to the partial samples PS with the manual-input labels MLB and unlabeled samples ULS of the text samples TS.

Reference is further made to FIG. 3E, which is a schematic diagram illustrating how to generate the prompt message PM according to the partial samples PS with the manual-input labels MLB and unlabeled samples ULS of the text samples TS in some embodiments.

In some embodiments, the prompt message PM may include an anchor data D_{AN}. As shown in FIG. 2 and FIG. 3E, in some embodiments, step S260 further includes steps S261, S262 and S263 to generate the anchor data D_{AN} of the prompt message PM. Step S261 is executed, by the processing unit 110, to calculate a clustering distribution of the keep samples TS_{KP}, and to select first anchor samples TS_{KAN} from the keep samples TS_{KP} according to a clustering distribution of the keep samples TS_{KP}. In some embodiments, the keep samples TS_{KP} adjacent to a clustering centroid of the keep samples TS_{KP} are selected as the first anchor samples TS_{KAN}. Other keep samples TS_{KP} not being selected as the first anchor samples TS_{KAN} are regarded as remaining keep samples TS_{Kleft}.

Step S262 is executed, by the processing unit 110, to calculate a clustering distribution of the remove samples TS_{RMV}, and to select second anchor samples TS_{RAN} from the remove samples TS_{RMV} according to a clustering distribution of the remove samples TS_{RMV}. In some embodiments, the remove samples TS_{RMV} adjacent to a clustering centroid of the remove samples TS_{RMV} are selected as the second anchor samples TS_{RAN}. Other keep samples TS_{KP} not being selected as the first anchor samples TS_{KAN} are regarded as remaining keep samples TS_{Kleft}. Step S263 is executed, by the processing unit 110, to combine the first anchor samples TS_{KAN} and the second anchor samples TS_{RAN} to form the anchor data D_{AN} in the prompt message PM.

In some embodiments, the prompt message PM may include an unlabeled data D_{UL}, and the unlabeled data D_{UL} can be a mixture of unlabeled samples ULS and some calibrator samples. As shown in FIG. 2 and FIG. 3E, in some embodiments, step S260 further includes steps S264, S265 and S266 to generate the unlabeled data D_{UL} of the prompt message PM. Step S264 is executed, by the processing unit 110, to calculate a similarity between the remaining keep samples TS_{Kleft} (i.e., the keep samples TS_{KP} not being selected as the first anchor samples TS_{KAN}) and the unlabeled samples ULS, and to select first calibrator samples TS_{Kcal} from the remaining keep samples TS_{Kleft}. In some embodiments, some of the remaining keep samples TS_{Kleft} similar to the unlabeled samples ULS are selected as the first calibrator samples TS_{Kcal}.

Step S265 is executed, by the processing unit 110, to calculate a similarity between the remaining remove samples TS_{Rleft} (i.e., the remove samples TS_{RMV} not being selected as the seocnd anchor samples TS_{RAN}) and the unlabeled samples ULS, and to select second calibrator samples TS_{Rcal} from the remaining remove samples TS_{Rleft}. In some embodiments, some of the remaining remove samples TS_{Rleft} similar to the unlabeled samples ULS are selected as the second calibrator samples TS_{Rcal}.

Step S266 is executed, by the processing unit 110, to mix the first calibrator samples TS_{Kcal} and the second calibrator samples TS_{Rcal} into the unlabeled samples ULS to form the unlabeled data D_{UL} in the prompt message PM.

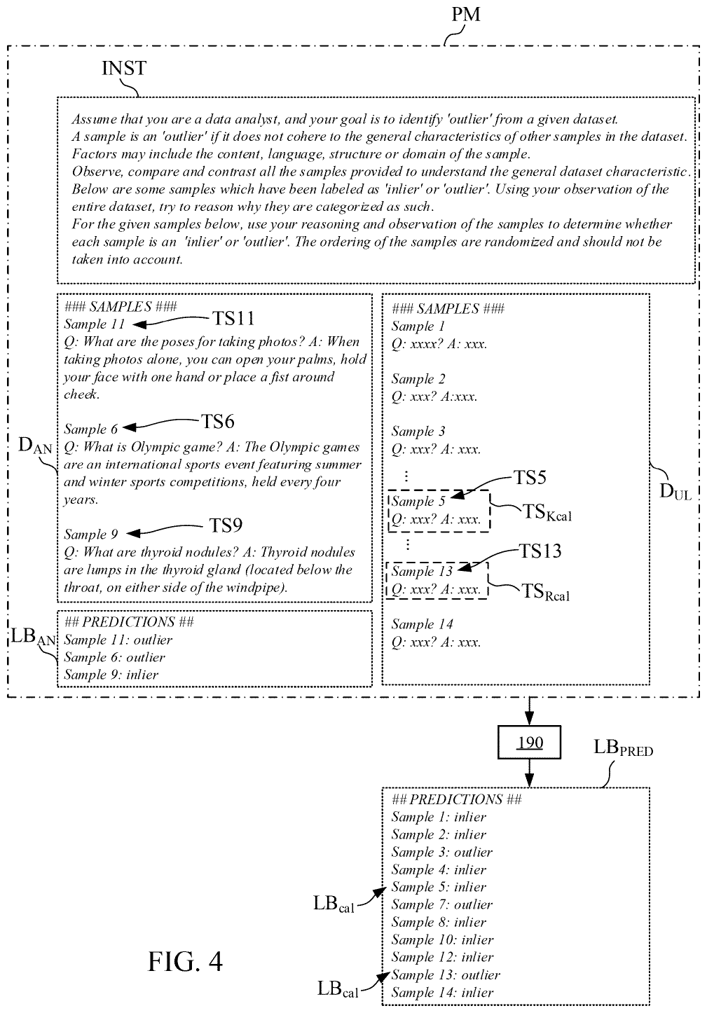

Reference is further made to FIG. 4, which is a schematic diagram illustrating the prompt message PM generated by step S260 (including steps S261-S266 shown in FIG. 3E) in some embodiments. As shown in FIG. 4, the prompt message PM includes a task instruction INST, the anchor data D_{AN} generated based on the partial samples PS, anchor label data LB_{AN} and the unlabeled data D_{UL}.

As shown in FIG. 4, the task instruction INST in the prompt message PM is configured to inform the generative pre-trained transformer model 190 to identify outliers in a given dataset. As shown in FIG. 4, the task instruction INST ask the generative pre-trained transformer model 190 to act as a data analyst to predict the inlier/outlier labels of the text samples within the unlabeled data D_{UL}, based on hints of the anchor data D_{AN} and the anchor label data LB_{AN}.

In the embodiments shown in FIG. 3D and FIG. 4, the text samples TS11 and TS6 of the remove samples TS_{RMV} and the text sample TS9 of the keep samples TS_{KP} are configured to form the anchor data D_{AN} in the prompt message PM. The manual-input labels about the text samples TS11, TS6 and TS9 are configured to form the anchor label data LB_{AN} in the prompt message PM.

In the embodiments shown in FIG. 3D and FIG. 4, the text sample TS5 of the keep samples TS_{KP} is configured to form the first calibrator sample TS_{Kcal}, and the text sample TS13 of the remove samples TS_{RMV} is configured to form the second calibrator sample TS_{Rcal}. The first calibrator sample TS_{Kcal} and the second calibrator sample TS_{Rcal} are mixed with other unlabeled samples ULS to form the unlabeled data D_{UL} in the prompt message PM.

As shown in FIG. 1, FIG. 2 and FIG. 4, step S270 is executed, by the processing unit 110 and the communication circuit 150, to provide the prompt message PM to the generative pre-trained transformer model 190 for generating inlier-outlier prediction labels LB_{PRED} about the unlabeled data D_{UL} (which includes the unlabeled samples ULS, the first calibrator sample TS_{Kcal} and the second calibrator sample TS_{Rcal}). In some embodiments, the generative pre-trained transformer model 190 will generate the inlier-outlier prediction labels LB_{PRED} about the unlabeled data D_{UL} based on the hints of the anchor data D_{AN} and the anchor label data LB_{AN} in the prompt message PM. The inlier-outlier prediction labels LB_{PRED} will predict whether each one of the unlabeled data D_{UL} is an inlier or an outlier.

In some embodiments, the manual-input labels MLB about the text samples TS5 and TS13 are not added to the contents of the prompt message PM. The first calibrator sample TS_{Kcal} and the second calibrator sample TS_{Rcal} are utilized to verify a confidence level about the inlier-outlier prediction labels LB_{PRED} generated by the generative pre-trained transformer model 190. In other words, the first calibrator sample TS_{Kcal} and the second calibrator sample TS_{Rcal} can be utilized to evaluate a preciseness of the inlier-outlier prediction labels LB_{PRED} generated by the generative pre-trained transformer model 190.

The inlier-outlier prediction labels LB_{PRED} generated by the generative pre-trained transformer model 190 include calibrator prediction labels LB_{cal} on the calibrator samples (i.e., the first calibrator sample TS_{Kcal} and the second calibrator sample TS_{Rcal}). The processing unit 110 is configured to compare the manual-input labels MLB about the text samples TS5 and TS13 with the calibrator prediction labels LB_{cal}. If the manual-input labels MLB match with the calibrator prediction labels LB_{cal}, the confidence level will be higher. If the manual-input labels MLB does not match with the calibrator prediction labels LB_{cal}, the confidence level will be lower.

In some embodiments, the electronic device 100 is configured to collect the inlier-outlier prediction labels LB_{PRED} from the pre-trained transformer model 190, and then the processing unit 110 is configured to remove text samples with outlier labels from the dataset DB, such that text samples remaining in the dataset DB will be clean data (i.e., inlier data) without noisy data.

Based on aforesaid embodiments, some partial samples PS are extracted from the whole dataset DB of text samples. A small number of partial samples PS require manual annotation. The partial samples PS are processed to provide the anchor data D_{AN} and calibrator data (e.g., the first calibrator sample TS_{Kcal} and the second calibrator sample TS_{Rcal}) in the prompt message PM. The prompt message PM is configured to trigger the generative pre-trained transformer model 190 to generate the inlier-outlier prediction labels LB_{PRED} about a large number of the unlabeled samples ULS. It can avoid to heavy loading on the human annotator for manually annotating a lot of text samples. The human annotator is required to label a small portion of the text samples, and most of the text samples can be processed automatically by the data classification method 200.

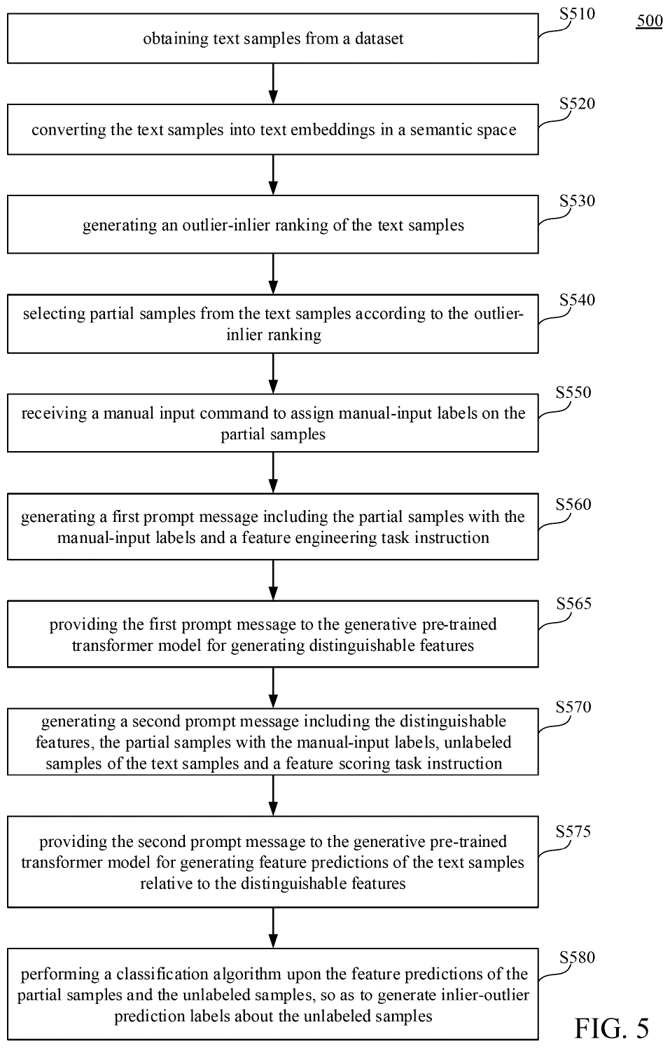

Reference is further made to FIG. 5, which is a flowchart illustrating a data classification method 500 according to other embodiments of the disclosure. The data classification method 500 can be executed by the electronic device 100 shown in FIG. 1. Similar to the data classification method 200 shown in FIG. 2, the data classification method 500 is configured to generate inlier-outlier predictions about text samples in the dataset DB.

As shown in FIG. 5, the data classification method 500 includes steps S510, S520, S530, S540, S550, S560, S565, S570, S575 and S580. Steps S510, S520, S530, S540 and S550 of the data classification method 500 in FIG. 5 are similar to the steps S210, S220, S230, S240 and S250 of the data classification method 200 in FIG. 2 and already discussed in embodiments shown in FIG. 3A, FIG. 3B, FIG. 3C and FIG. 3D. Details about steps S510, S520, S530, S540 and S550 are not repeated again.

As shown in FIG. 3D and FIG. 5, in step S550, the manual-input labels MLB include keep labels on the text samples TS5 and TS9, such that the text samples TS5 and TS9 are regarded as keep samples TS_{KP} among the partial samples PS. On the other hand, the manual-input labels MLB include remove labels on the text samples TS6, TS11 and TS13, such that the text samples TS6, TS11 and TS13 are regarded as remove samples TS_{RMV} among the partial samples PS.

As shown in FIG. 1 and FIG. 5, step S560 is executed, by the processing unit 110, to generate a first prompt message that includes the partial samples with the manual-input labels and a feature engineering task instruction.

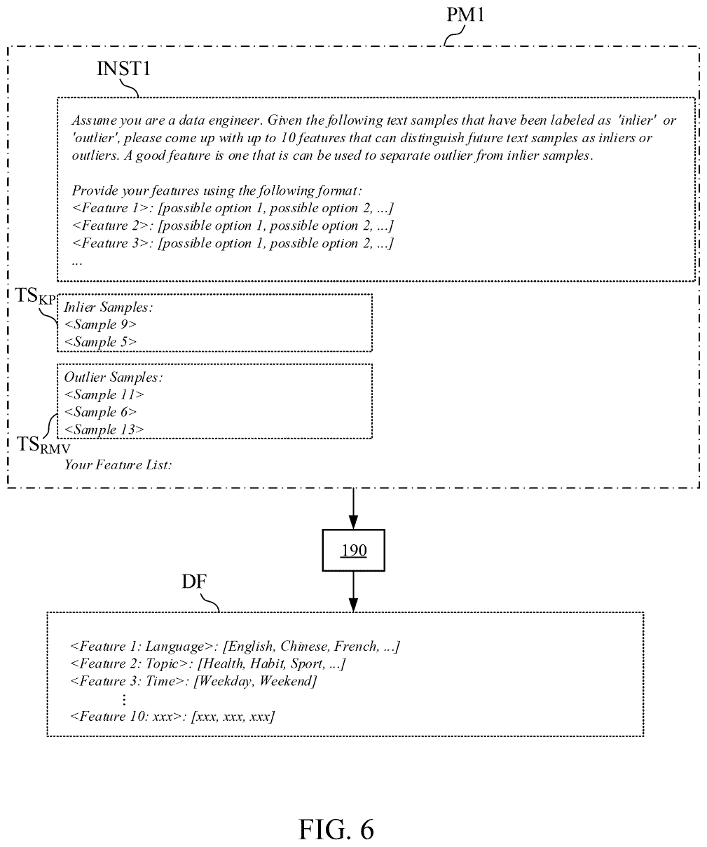

Reference is further made to FIG. 6, which is a schematic diagram illustrating the first prompt message PM1 generated by step S560 in some embodiments. As shown in FIG. 6, the first prompt message PM1 includes a feature engineering task instruction INST1, the keep samples TS_{KP} and remove samples TS_{RMV}.

The keep samples TS_{KP} and remove samples TS_{RMV} are the partial samples PS with the manual-input labels MLB, which are utilized to provide hints for the generative pre-trained transformer model 190 to achieve the feature engineering task.

The feature engineering task instruction INST1 in the first prompt message PM1 is configured to trigger the generative pre-trained transformer model 190 to generate the distinguishable features DF capable of separating the remove samples TS_{RMV} from the keep samples TS_{KP}.

As shown in FIG. 1, FIG. 5 and FIG. 6, step S565 is executed, by the processing unit 110 and the communication circuit 150, to provide the first prompt message PM1 to the generative pre-trained transformer model 190 for generating the distinguishable features DF. As shown in FIG. 6, the generative pre-trained transformer model 190 is instructed by the first prompt message PM1 to generate 10 feature sets of the distinguishable features DF.

As shown in FIG. 1 and FIG. 5, step S570 is executed, by the processing unit 110, to generate a second prompt message that includes the distinguishable features DF, the text samples and a feature scoring task instruction.

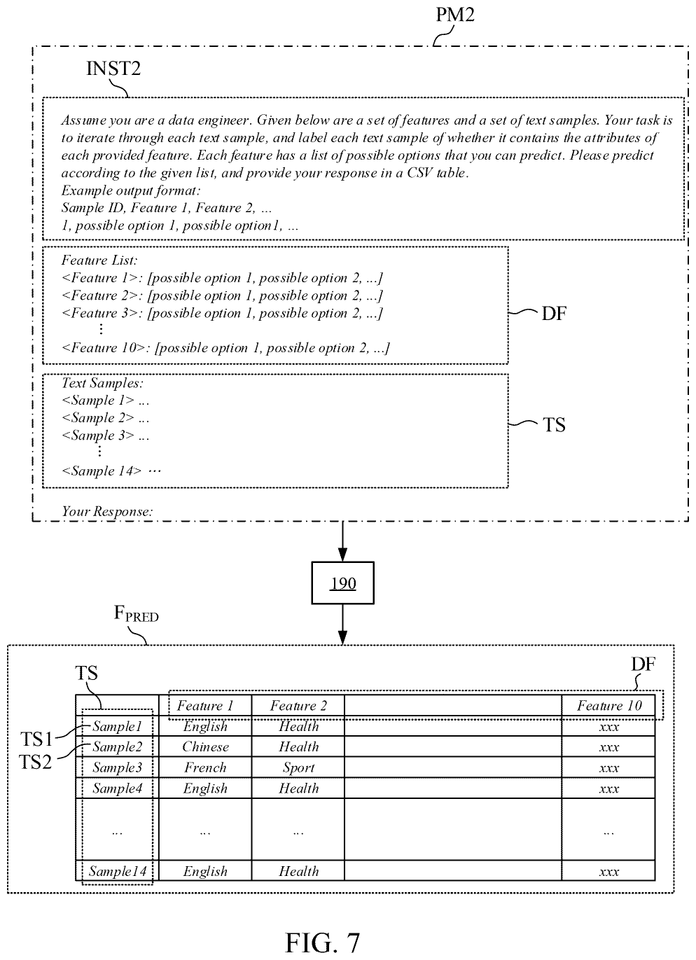

Reference is further made to FIG. 7, which is a schematic diagram illustrating the second prompt message PM2 generated by step S570 in some embodiments. As shown in FIG. 7, the second prompt message PM2 includes a feature scoring task instruction INST2, the text samples TS and the distinguishable features DF.

In some embodiments, the feature scoring task instruction INST2 in the second prompt message PM2 is configured to trigger the generative pre-trained transformer model to distinguish whether the text samples TS have attributes matching with possible options of the distinguishable features DF.

As shown in FIG. 1, FIG. 5 and FIG. 7, step S575 is executed, by the processing unit 110 and the communication circuit 150, to provide the second prompt message PM2 to the generative pre-trained transformer model 190 for feature predictions F_{PRED} of the text samples TS relative to the distinguishable features DF. As shown in FIG. 7, the feature predictions F_{PRED} indicate that the text sample TS1 is a text passage in English about health topic, and also indicate that the text sample TS2 is a text passage in Chinese about health topic. In some embodiments, the distinguishable features DF are human recognizable features (e.g., languages, topics, times, lengths) as shown in FIG. 6 and FIG. 7. In other embodiments, the distinguishable features DF may include human un-recognizable features (e.g., latent vectors).

As shown in FIG. 1 and FIG. 5, step S580 is executed, by the processing unit 110, to perform a classification algorithm to generate inlier-outlier prediction labels about the unlabeled samples.

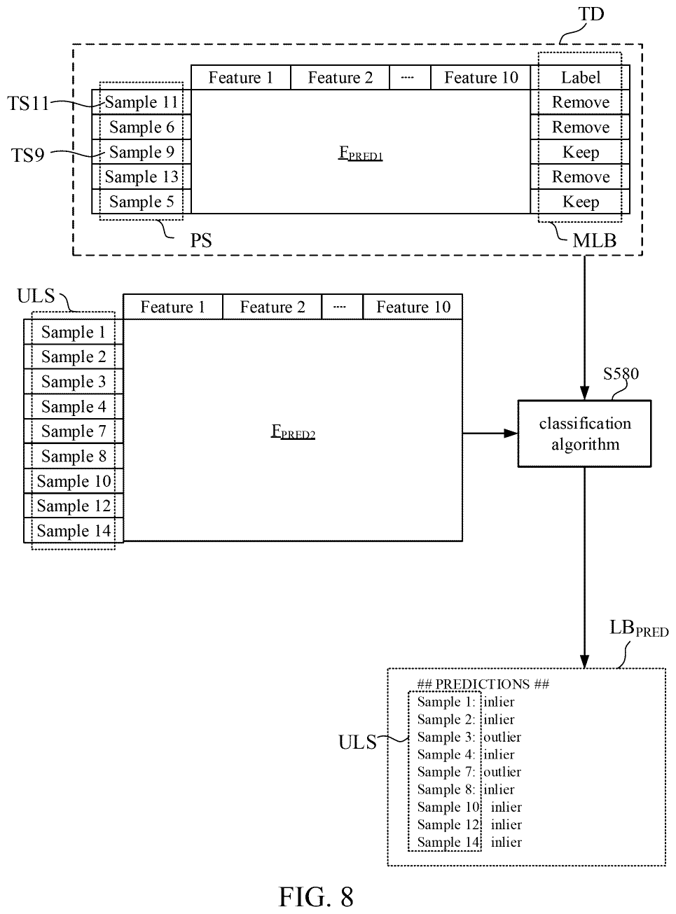

Reference is further made to FIG. 8, which is a schematic diagram illustrating how to generate inlier-outlier prediction labels LB_{PRED} by the classification algorithm in step S580 in some embodiments.

As shown in FIG. 8, the classification algorithm in step S580 is performed based on feature predictions F_{PRED1} of the partial samples PS and feature predictions F_{PRED2} of the unlabeled samples ULS, so as to generate inlier-outlier prediction labels LB_{PRED} about the unlabeled samples ULS. In some embodiments, since the text samples TS includes the partial samples PS and the unlabeled samples ULS, the feature predictions F_{PRED1} of the partial samples PS and feature predictions F_{PRED2} of the unlabeled samples ULS in FIG. 8 are derived from the feature predictions F_{PRED} of the text samples TS in FIG. 7.

As shown in FIG. 8, the classification algorithm in step S580 is performed based on a training data TD that includes the feature predictions F_{PRED1} of the partial samples PS and the manual-input labels MLB of the partial samples PS, so as to generate the inlier-outlier prediction labels LB_{PRED} about the unlabeled samples ULS according to the feature predictions F_{PRED2} of the unlabeled samples ULS.

For example, if one of the unlabeled samples ULS has a set of feature prediction F_{PRED2} similar to the feature prediction F_{PRED1} of the text sample TS11, this one of the unlabeled sample ULS may be classified as outlier by the classification algorithm. If one of the unlabeled samples ULS has a set of feature prediction F_{PRED2} similar to the feature prediction F_{PRED1} of the text sample TS9, this one of the unlabeled sample ULS may be classified as inlier by the classification algorithm. In some embodiments, the classification algorithm in step S580 can be implemented by XGBoost algorithm, CatBoost algorithm or Random Forest algorithm.

In some embodiments, XGBoost algorithm will generate a prediction score for each text sample. When the prediction score of one text sample is larger than 0.5 (e.g., the prediction score=0.7), this text sample can be labeled as inlier with a confidence level equal to its score (e.g., the confidence level=0.7). When the prediction score of one text sample is lower than 0.5 (e.g., the prediction score=0.2), this text sample can be labeled as outlier with a confidence level equal to a complement of its score (e.g., the confidence level=1−0.2=0.8).

Based on aforesaid embodiments, some partial samples PS are extracted from the whole dataset DB of text samples. A small number of partial samples PS require manual annotation. The partial samples PS are processed to provide the first prompt message PM1 and the second prompt message PM2. The first prompt message PM1 and the second prompt message PM2 are configured to trigger the generative pre-trained transformer model 190 to perform a feature engineering task and a feature scoring task. Based on feedbacks from the pre-trained transformer model 190, the inlier-outlier prediction labels LB_{PRED} about a large number of the unlabeled samples ULS can be generated. It can avoid to heavy loading on the human annotator for manually annotating a lot of text samples. The human annotator is required to label a small portion of the text samples, and most of the text samples can be processed automatically by the data classification method 500.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A data classification method, comprising:
obtaining text samples from a dataset;
converting the text samples into text embeddings in a semantic space;
generating an outlier-inlier ranking of the text samples based on an outlier detection algorithm according to distances between the text embeddings in the semantic space;
selecting partial samples from the text samples according to the outlier-inlier ranking;
receiving a manual input command to assign manual-input labels on the partial samples; and
generating a prompt message according to the partial samples with the manual-input labels and unlabeled samples of the text samples, wherein the prompt message comprises a task instruction, unlabeled data and anchor data generated based on the partial samples with the manual-input labels; and
providing the prompt message to a generative pre-trained transformer model for generating inlier-outlier prediction labels about the unlabeled samples.

2. The data classification method of claim 1, wherein at least one of the text samples prone to be outlier according to the outlier-inlier ranking are selected as the partial samples, an amount of the partial samples is fewer than an amount of the unlabeled samples.

3. The data classification method of claim 1, wherein the manual input command is configured to assign keep labels on keep samples among the partial samples and assign remove labels on remove samples among the partial samples, generating the prompt message comprising:
selecting first anchor samples from the keep samples according to a clustering distribution of the keep samples;
selecting second anchor samples from the remove samples according to a clustering distribution of the remove samples; and
combining the first anchor samples and the second anchor samples to form the anchor data in the prompt message.

4. The data classification method of claim 3, wherein generating the prompt message further comprising:
selecting first calibrator samples from the keep samples not being selected as the first anchor samples;
selecting second calibrator samples from the remove samples not being selected as the second anchor samples; and
forming the unlabeled data in the prompt message according to a mixture of the unlabeled samples, the first calibrator samples and the second calibrator samples.

5. The data classification method of claim 4, wherein the first calibrator samples and the second calibrator samples are utilized to verify a confidence level about the inlier-outlier prediction labels generated by the generative pre-trained transformer model.

6. The data classification method of claim 4, wherein selecting the first calibrator samples comprises:
comparing similarities between the keep samples not being selected as the first anchor samples and the unlabeled samples; and
selecting the first calibrator samples according to the similarities.

7. The data classification method of claim 1, wherein the task instruction in the prompt message is configured to inform the generative pre-trained transformer model to identify outliers in a given dataset.

8. The data classification method of claim 1, wherein the outlier detection algorithm is implemented by a RANSAC-NN algorithm, an Isolation Forest algorithm or a Local Outlier Factor algorithm.

9. The data classification method of claim 1, wherein each of the text samples comprises a text passage or a combination of a question and a response.

10. A data classification method, comprising:
obtaining text samples from a dataset;
converting the text samples into text embeddings in a semantic space;
generating an outlier-inlier ranking of the text samples based on an outlier detection algorithm according to distances between the text embeddings in the semantic space;
selecting partial samples from the text samples according to the outlier-inlier ranking;
receiving a manual input command to assign manual-input labels on the partial samples; and
generating a first prompt message comprising the partial samples with the manual-input labels and a feature engineering task instruction;
providing the first prompt message to a generative pre-trained transformer model for generating distinguishable features;
generating a second prompt message comprising the distinguishable features, the text samples and a feature scoring task instruction;
providing the second prompt message to the generative pre-trained transformer model for generating feature predictions of the text samples relative to the distinguishable features; and
performing a classification algorithm based on the feature predictions of the text samples comprising the partial samples and unlabeled samples, so as to generate inlier-outlier prediction labels about the unlabeled samples.

11. The data classification method of claim 10, wherein at least one of the text samples prone to be outlier according to the outlier-inlier ranking are selected as the partial samples, an amount of the partial samples is fewer than an amount of the unlabeled samples.

12. The data classification method of claim 10, wherein the manual input command is configured to assign keep labels on keep samples among the partial samples and assign remove labels on remove samples among the partial samples.

13. The data classification method of claim 12, wherein the feature engineering task instruction in the first prompt message is configured to trigger the generative pre-trained transformer model to generate the distinguishable features capable of separating the remove samples from the keep samples.

14. The data classification method of claim 10, wherein the feature scoring task instruction in the second prompt message is configured to trigger the generative pre-trained transformer model to distinguish whether the text samples have attributes of the distinguishable features.

15. The data classification method of claim 10, wherein the classification algorithm is performed based on a training data comprising the feature predictions of the partial samples and the manual-input labels of the partial samples, so as to generate the inlier-outlier prediction labels about the unlabeled samples according to the feature predictions of the unlabeled samples.

16. The data classification method of claim 10, wherein the classification algorithm is implemented by XGBoost algorithm, CatBoost algorithm or Random Forest algorithm.

17. The data classification method of claim 10, wherein the outlier detection algorithm is implemented by a RANSAC-NN algorithm, an Isolation Forest algorithm or a Local Outlier Factor algorithm.

18. The data classification method of claim 10, wherein each of the text samples comprises a text passage or a combination of a question and a response.
